(19) United States
(12) Patent Application Publication
(10) Pub. No.: US 2025/0156218 A1
(43) Pub. Date: May 15, 2025

(54) METHOD AND DEVICE FOR PROCESSING A TASK, ELECTRONIC DEVICE, AND STORAGE MEDIUM

(71) Applicant: Beijing Zitiao Network Technology Co., Ltd., Haidian District, Beijing (CN)

(72) Inventor: Jiong DU, Beijing (CN)

(21) Appl. No.: 18/832,889

(22) PCT Filed: Jan. 19, 2023
(86) PCT No.: PCT/CN2023/073256

§ 371 Date: Jul. 24, 2024

(30) Foreign Application Priority Data
Jan. 24, 2022 (CN) 202210079796.9

(51) Int. Cl. G06F 9/48; H04N 21/2187

(52) U.S. Cl. CPC G06F 9/485; G06F 9/4881; H04N 21/2187

(57) ABSTRACT

A method for processing a task, a device for processing a task, an electronic device, and a storage medium are provided. The method includes: acquiring a task processing factor transmitted by a first client; generating a task processing rule based on the task processing factor; determining task processing data corresponding to a plurality of second clients; determining a task processing result based on the task processing rule and the task processing data; and transmitting the task processing result to a third client.

### CROSS-REFERENCE TO RELATED APPLICATION

The present application claims priority of the Chinese Patent Application No. 202210079796.9, filed Jan. 24, 2022, entitled “TASK PROCESSING METHOD AND DEVICE, STORAGE MEDIUM, AND PROGRAM PRODUCT,” the disclosure of which is incorporated herein by reference in its entirety as part of the present application.

### TECHNICAL FIELD

Embodiments of the present disclosure relate to the field of computer and network communication technology, in particular to a task processing method and device, a storage medium, and a program product.

### BACKGROUND

With the development of mobile Internet, live streaming has gradually become an indispensable part of people's life and entertainment. In a session of live streaming, a streamer may create a live streaming room and a live streaming task, and other users may enter into the live streaming room to participate in the live streaming task and view a live streaming task result.

In the prior art, a live streaming task result may be usually judged by a person subjectively. For example, the streamer may judge a task result by listening and watching in real time.

However, in the process of implementing the present disclosure, the inventor has found at least the following problems in the prior art: the existing manner is subjective and the accuracy of the live streaming task result cannot be guaranteed; moreover, the manner of making a judgment by watching the content of the whole live streaming process takes a long time and is less efficient.

### SUMMARY

Embodiments of the present disclosure provide a task processing method and device, a storage medium, and a program product, so as to overcome the problems that the existing manner is subjective and the accuracy of the live streaming task result cannot be guaranteed, and the problem that the manner of making the judgment by watching the content of the whole live streaming process takes the long time and is less efficient.

In the first aspect, embodiments of the present disclosure provide a method for processing a task, which includes:
acquiring a task processing factor transmitted by the first client;
generating a task processing rule based on the task processing factor;
determining task processing data corresponding to a plurality of second clients;
determining a task processing result based on the task processing rule and the task processing data; and
transmitting the task processing result to the third client.

In the second aspect, embodiments of the present disclosure provide a method for processing a task, applied to the first client, which includes:
displaying a task setting interface; and
in response to a task processing factor setting operation on the task setting interface, transmitting the task processing factor to a server to make the server generate a task processing rule based on the task processing factor, determine a task processing result based on the task processing rule and task processing data corresponding to a plurality of second clients, and transmit the task processing result to the third client.

In the third aspect, embodiments of the present disclosure provide a device for processing a task, which includes: an acquisition module, a rule generation module, a data determination module, a result determination module, and the first transmission module.

The acquisition module is configured to acquire a task processing factor transmitted by the first client.

The rule generation module is configured to generate a task processing rule based on the task processing factor.

The data determination module is configured to determine task processing data corresponding to a plurality of second clients.

The result determination module is configured to determine a task processing result based on the task processing rule and the task processing data.

The first transmission module is configured to transmit the task processing result to the third client.

In the fourth aspect, embodiments of the present disclosure provide a device for processing a task, which includes: a display module and the second transmission module.

The display module is configured to display a task setting interface.

The second transmission module is configured to in response to a task processing factor setting operation on the task setting interface, transmit the task processing factor to a server to make the server generate a task processing rule based on the task processing factor, and determine a task processing result based on the task processing rule and task processing data corresponding to a plurality of second clients and transmitting the task processing result to the third client.

In the fifth aspect, embodiments of the present disclosure provide an electronic device, which includes: a processor and a memory.

The memory stores computer executable instructions.

The processor executes the computer executable instructions stored on the memory, causing the processor to perform the method for processing a task as described in the first aspect above and in various possible designs of the first aspect.

In the sixth aspect, embodiments of the present disclosure provide an electronic device, which includes: a display, a processor and a memory.

The memory stores computer executable instructions; the display is connected to the processor and configured to display a task setting interface.

The processor executes the computer executable instructions stored on the memory, causing at least one processor perform the method for processing a task as described in the second aspect above.

In the seventh aspect, embodiments of the present disclosure provide a computer readable storage medium, computer executable instructions are stored in the computer readable storage medium, and the computer executable instructions, when executed by a processor, implement the method for processing a task as described in the first aspect above and in various possible designs of the first aspect, or, implement the method for processing a task as described in the second aspect above.

In the eighth aspect, embodiments of the present disclosure provide a computer program product including a computer program, the computer program when executed by a processor, implements the method for processing a task as described in the first aspect above and in various possible designs of the first aspect, or, implements the method for processing a task as described in the second aspect above.

In the ninth aspect, embodiments of the present disclosure provide a computer program, the computer program when executed by a processor, implements the method for processing a task as described in the first aspect above and in various possible designs of the first aspect, or, implements the method for processing a task as described in the second aspect above.

### BRIEF DESCRIPTION OF DRAWINGS

In order to make the purpose, technical scheme and advantages of the embodiment of the disclosure more clearly, the technical scheme in the embodiment of the disclosure is described clearly and completely with the attached drawings. Obviously, the described embodiment is a part of the embodiment of the disclosure, but not the whole embodiment. Based on the embodiments of the present disclosure, all other embodiments acquired by the person of ordinary skill in the art without creative work belong to the protection scope of the present disclosure.

FIG. 1 is a schematic diagram of an application scenario of a method for processing a task provided in an embodiment of the present disclosure;

FIG. 2 is the first flowchart of a method for processing a task provided in an embodiment of the present disclosure;

FIG. 3 is a schematic diagram of a method for processing a task provided in an embodiment of the present disclosure;

FIG. 4 is the second flowchart of a method for processing a task provided in an embodiment of the present disclosure;

FIG. 5 is the first schematic diagram of a task setting interface provided in an embodiment of the present disclosure;

FIG. 6 is the second schematic diagram of a task setting interface provided in an embodiment of the present disclosure;

FIG. 7 is the third schematic diagram of a task setting interface provided in an embodiment of the present disclosure;

FIG. 8 is the first structural block diagram of a device for processing a task provided in an embodiment of the present disclosure;

FIG. 9 is the second structural block diagram of a device for processing a task provided in an embodiment of the present disclosure; and

FIG. 10 is a schematic diagram of a hardware structure of an electronic device provided in an embodiment of the present disclosure.

### DETAILED DESCRIPTION

To make the objectives, technical solutions, and advantages of the embodiments of the present disclosure clearer, the following clearly and completely describes the technical solutions in the embodiments of the present disclosure with reference to the accompanying drawings in the embodiments of the present disclosure. Apparently, the described embodiments are some but not all of the embodiments of the present disclosure. All other embodiments acquired by a person of ordinary skill in the art based on the embodiments of the present disclosure without creative efforts should fall within the protection scope of the present disclosure.

With the development of mobile Internet, live streaming has gradually become an indispensable part of people's life and entertainment. Live streaming is typically presented in the form of a live streaming room. For example, there may be a talk-show live streaming room, a KTV live streaming room, and the like. Taking the KTV live streaming room for example, the KTV live streaming room may be created by a streamer, and then other users may enter into the live streaming room to sing songs of their own choices. To improve the popularity of the live streaming room, the streamer may determine a task result from a performance task of the streamer or another user to improve the subsequent live streaming content.

In the prior art, the streamer may judge the result of the performance task by listening and watching in real time. However, the existing judgment manner is subjective and lack of data support. The accuracy of judgment cannot be guaranteed, and watching the content of the whole live streaming process takes too much time and is less efficient.

To solve the above problems, the inventor of the present disclosure has found by research that a corresponding task processing rule may be generated based on a task processing factor selected by a user, realizing rapid multi-dimensional determination of a task result. On this basis, an embodiment of the present disclosure provides a method for processing a task that can realize multi-dimensional determination of the task result, thereby greatly reducing the subjectivity of a mining process and improving the accuracy and efficiency of task processing.

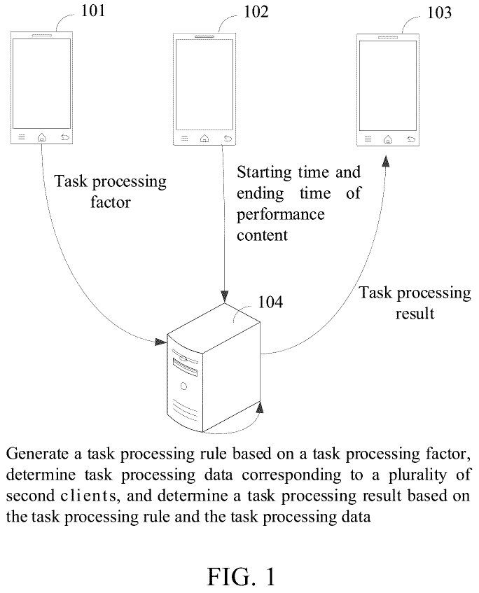

With reference to FIG. 1, FIG. 1 is a schematic diagram of an application scenario of a method for processing a task provided in an embodiment of the present disclosure. As shown in FIG. 1, the first client 101, the second client 102, and the third client 103 are all connected to a device for processing the task 105. The first client is, for example, a streamer side; the second client is, for example, a guest side; and the third client is, for example, an audience side. Taking live streaming in the form of a live stream for example, the first client 101 is configured to create a live stream in response to an instruction input by a streamer, allowing a performing user to enter into the live streaming room by means of the second user terminal 102 to perform, and also configured to transmit a task processing factor selected to the device for processing the task 105 in response to the streamer's setting operation on the task processing factor in a task setting interface. The second client 102 is configured to record a performance task of the performing user in response to a starting instruction or ending instruction input by the performing user, and also transmit a starting time and an ending time of the performance task to the device for processing the task 105. The third client 103 is configured to, in response to an interactive instruction from a watching user who enters into the live streaming room to watch the performance task, generate task processing data corresponding to a plurality of second clients 102. The third client 103 may directly transmit the task processing data to the device for processing the task 105, or firstly store the task processing data on a server and then transmit the task processing data to the device for processing the task 105 by the server. The device for processing the task 105 is configured to acquire the task processing factor transmitted by the first client 101, generate a task processing rule based on the task processing factor, determine the task processing data corresponding to the plurality of second clients 102, determine a task processing result based on the task processing rule and the task processing data, and transmit the task processing result to the third client 103.

It needs to be noted that the first client 101, the second client 102, and the third client 103 are functionally divided, and a hardware terminal may carry a function realized by at least one of clients described above. For example, the third client 103 may be the first client 101 employed by the streamer, or the second client 102 employed by the performing user, or a terminal employed by the watching user. The present embodiment does not define this.

In a specific implementation, the first client 101 creates the live stream in response to the instruction input by the streamer, and transmits the task processing factor selected by the streamer to the device for processing the task 105 in response to the streamer's setting operation on the task processing factor in the task setting interface. The second client 102 records the performance task of the performing user in response to the starting instruction or the ending instruction input by the performing user, and may transmit the starting time and the ending time of the performance task to the device for processing the task 105. The third client 103 generates the task processing data corresponding to the plurality of second clients 102 in response to the interactive instruction from the watching user who enters into the live streaming room to watch the performance task, and may transmit the task processing data to the device for processing the task 105 directly or indirectly by means of a device such as a server. The device for processing the task 105 acquires the task processing factor transmitted by the first client 101, generates the task processing rule based on the task processing factor, determines the task processing data corresponding to the plurality of second clients 102, determines the task processing result based on the task processing rule and the task processing data, and transmits the task processing result to the third client 103. For example, the task processing result may be transmitted to the first client 101 of the streamer so that the streamer can rapidly mine a valuable hot content to optimize the live streaming program and improve the popularity of the live streaming room.

As can be known from the above description, the method for processing the task provided in the present embodiment includes generates the corresponding task processing rule based on the task processing factor transmitted by the first client, and acquires the corresponding task processing result based on the generated task processing rule. Multi-dimensional determination of the task result can be realized, the subjectivity of the mining process can be greatly reduced, and the accuracy and efficiency of task processing can be improved.

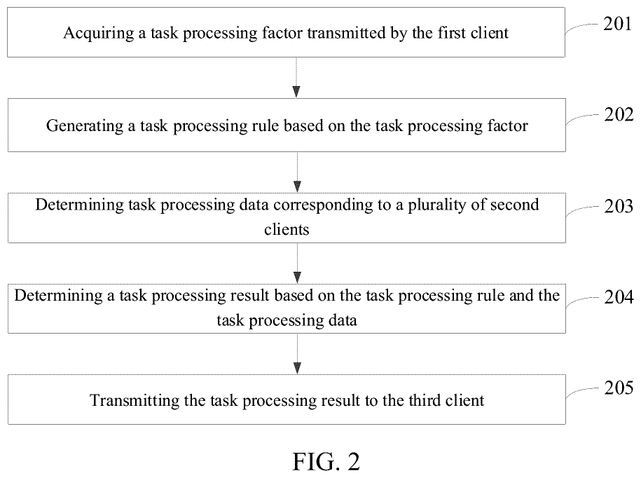

With reference to FIG. 2, FIG. 2 is a flowchart of a method for processing a task provided in an embodiment of the present disclosure. The method for processing the task of the present embodiment may be applied to the device for processing the task 104 as shown in FIG. 1. The method for processing the task includes the following steps.

201, acquiring a task processing factor transmitted by the first client.

The task processing factor may be a type of task processing data acquired in the playing process of a performance task, and the type may include an interactive data type (a number/magnitude of likes, a number/magnitude of comments), a resource type (a gift type), and the like. The performance task may be a variety of types of performances, such as song, dance, talk show, or cross talk, which is not defined in the present embodiment.

202, generating a task processing rule based on the task processing factor.

Specifically, upon acquiring the task processing factor, e.g., the magnitude of comments, transmitted by the first client, the corresponding task processing rule may be generated. For example, N performance tasks are determined based on the magnitude of comments, where N is a positive integer. The task processing rule is a judgment condition for a user to determine the task processing result, and the task processing factor is a judgment factor corresponding to the task processing rule and used for generating the judgment condition.

Optionally, the task processing factor may include a plurality of factors. The generating the task processing rule based on the task processing factor may include: performing weighted summation on each factor of the task processing factor to generate the task processing rule.

Exemplarily, the task processing factor may include two factors: a number/magnitude of comments and a number/magnitude of likes. The number/magnitude of comments and the number/magnitude of likes may be subjected to weighted summation to acquire the task processing rule.

203, determining task processing data corresponding to a plurality of second clients.

Specifically, after the task processing rule is generated based on the selected task processing factor, the respective task processing data corresponding to the performance tasks of the plurality of second clients may be calculated according to the task processing rule. Exemplarily, assuming that the task processing rule is screening or sorting tasks based on a weighted sum of the magnitude of comments and the magnitude of likes, for each performance task, the magnitude of comments and the magnitude of likes are acquired in the playing process of the performance task, and the weighted sum of both is used as the task processing data of the performance task.

For each performance task of each second client, there are a plurality of ways of determining the task processing data of the performance task.

In an implementation, the task processing data may be accumulated, when a starting instruction for the performance task is received, i.e., after a touch operation of a performer on a performance starting control in a display interface is received, e.g., a number of comments corresponding to tasks is accumulated when an ending instruction for the performance task is received, i.e., after receiving a touch operation of the performer on a performance ending control in the display interface, the accumulation of the number of comments may be terminated, and a current accumulated value is determined as the number of comments for the performance task.

In another implementation, assuming that the task is the task for the live streaming room and each task for the live streaming room includes a plurality of performance tasks, the task processing data corresponding to the live streaming room is acquired, where the live streaming room is one where the first client, the second client, and the third client stay; and the task processing data corresponding to the plurality of second clients is determined based on the task processing data corresponding to the live streaming room, the task starting time and the task ending time corresponding to each second client. Optionally, the task processing data corresponding to the live streaming room includes a plurality of live streaming points and corresponding task processing data, and the plurality of live streaming points includes a task starting point and a task ending point corresponding to each second client; and the determining the task processing data corresponding to the plurality of second clients based on the task processing data corresponding to the live streaming room, and the task starting time and the task ending time corresponding to each second client includes: determining task processing data corresponding to the task ending points and task processing data corresponding to the task starting points based on the plurality of live streaming points and the corresponding task processing data; and for each second client, determining a difference value between the task processing data corresponding to the task ending point and the task processing data corresponding to the task starting point as the task processing data.

In still another implementation, a plurality of performance tasks come from a plurality of live streaming rooms, and each performance task includes a live streaming room identifier. For the live streaming room corresponding to each live streaming room identifier, the task processing data generated in the live streaming room may be accumulated from the live streaming starting time of the live streaming room to acquire an accumulated value of the task processing data, the accumulated value includes a generation time of the task processing data, and the starting time and the ending time of each performance task in the live streaming room are acquired. Task processing data corresponding to each performance task under each live streaming room identifier is determined based on the task processing rule, the accumulated value under the live streaming room identifier, and the starting time and the ending time of each performance task. Specifically, for each performance task under each live streaming room identifier, the first accumulated value of the accumulated values under the live streaming room identifier that corresponds to the starting time of the performance task and the second accumulated value of the accumulated values under the live streaming room identifier that corresponds to the ending time of the performance task are acquired; and a difference value between the first accumulated value and the second accumulated value is determined as the task processing data of the performance task.

204, determining a task processing result based on the task processing rule and the task processing data.

Specifically, after the task processing rule is generated based on the task processing factor, e.g., the magnitude of comments, for example, for the plurality of performance tasks corresponding to the plurality of second clients, the first N performance tasks are screened based on a relationship of the magnitude of comments corresponding to the plurality of performance tasks. Each performance task may be processed based on the task processing rule and the determined task processing data corresponding to each performance task to acquire the task processing result. For example, acquiring the first N performance tasks of the plurality of performance tasks in relation to the magnitude.

205, transmitting the task processing result to the third client.

Specifically, after the task processing result is acquired, e.g., after the first N performance tasks of the plurality of performance tasks of the plurality of second clients are acquired, the task processing result may be transmitted to the third client. The third client may be the first client corresponding to the streamer, or the second client corresponding to the performing user, or the third client corresponding to the watching user.

As can be known from the above description, the present embodiment includes generates the corresponding task processing rule based on the task processing factor transmitted by the first client, and acquires the corresponding task processing result based on the generated task processing rule. Multi-dimensional determination of the task result can be realized, the subjectivity of the mining process can be greatly reduced, and the accuracy and efficiency of task processing can be improved.

In one embodiment of the present disclosure, for example, on the basis of the embodiment shown in FIG. 2, to facilitate rapid acquiring of valuable information by the user, a task sorting result may be specifically acquired and transmitted to the third client in the present embodiment. Specifically, step 204 may include: determining a task execution result corresponding to each second client based on the task processing rule and Task processing data corresponding to each second client; and sorting the task execution results corresponding to the second clients to acquire the task sorting result.

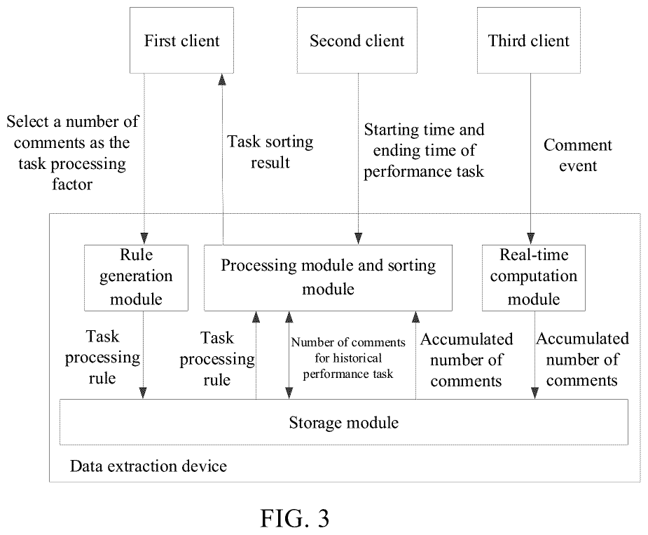

For ease of understanding, the above implementation is explained below as an example with reference to FIG. 3: the first client transmits the task processing factor, e.g. the magnitude of comments, selected by the streamer to a rule generation module of the device for processing the task. The second client may transmit the starting time and the ending time of the current performance task to the device for processing the task after the performance task ends, and the terminal of the watching user transmits a user comment event (the time of occurrence of the comment) to a real-time computation module of the device for processing the task. The real-time computation module is configured to accumulate the comment events from the start of live streaming of the live streaming room to acquire an accumulated number of comments, and store the accumulated number of comments in a storage module, the rule generation module is configured to generate the task processing rule based on the number of comments and store the task processing rule in the storage module, a processing module and a sorting module are configured to acquire the task processing rule and the accumulated number of comments, in which the processing module is configured to acquire the first accumulated value and the second accumulated value based on the starting time and the ending time of the performance task, respectively, and determine the difference between the first accumulated value and the second accumulated value as the number of comments for the performance task, where the number of comments is the task processing data of the performance task. After the number of comments for each performance task, i.e. a historical performance task, in a current sorting list is acquired, the sorting module is configured to sort a plurality of numbers of comments based on the task processing rule, i.e., a rule of sorting from a large number of comments to a small number of comments, to acquire the task sorting result, and transmit the task sorting result to the first client, allowing the streamer to rapidly mine a valuable hot content to optimize the live streaming program and improve the popularity of the live streaming room.

In one embodiment of the present disclosure, to enable the user to obtain the latest performance task sorting condition in time, the present embodiment also introduces real-time updating of the task sorting result, and after acquiring the task sorting result, may further include: determining the task processing data of the current performance task based on the task processing rule and the starting time and the ending time of the current performance task; comparing the task processing data of the current performance task with the task processing data corresponding to each performance task in the task sorting result, and updating the task sorting result based on a comparison result.

As can be known from the above description, by updating the task sorting result in real time in the live streaming process, the user can see the latest sorting condition to mine the valuable performance task in time.

In one embodiment of the present disclosure, on the basis of the embodiment of FIG. 2, to facilitate a user's operation, before step 201 of the above embodiment, the method for processing the task may further include: invoking the task processing rule set last time as the current task processing rule to generate the task sorting result. Correspondingly, after step 201, the method for processing the task further includes: storing the task processing rule as the current task processing rule.

Specifically, the task processing rule generated based on the task processing factor selected by the user may be stored as the current task processing rule, and the task sorting result is generated based on the current task processing rule. When the streamer exists the live streaming room temporarily and returns to the live streaming room again, or when the user creates a new live streaming room for new live streaming after the live streaming of the current live streaming room ends, the current task processing rule may be invoked to generate the task sorting result. When the user selects a new task processing factor, the newly generated task processing rule is determined as the current task processing rule.

As can be known from the above description, according to the method for processing the task provided in the present embodiment, the task processing rule may be stored in response to a saving request from the user, thereby facilitating the user's use and enhancing the user experience.

In one embodiment of the present disclosure, on the basis of the embodiment shown in FIG. 2, to improve the showing flexibility of the task processing result, an option of a sequence length is added in the embodiment of the present disclosure. Step 201 specifically includes: determining a target sequence length of the task sorting result, and generating the task processing rule based on the task processing factor and the target sequence length.

Exemplarily, when a large number of performance tasks are involved in sorting, for example, when the user selects a plurality of sessions of live streaming, i.e., the performance tasks of a plurality of live streaming rooms are involved in sorting, or when the current live streaming room has a large number of performance tasks, the user may define a showing number corresponding to task result, and the user experience is enhanced.

As can be known from the above description, by providing the user with the option of the sequence length, the task results needing to be shown can be displayed for the user, and the efficiency is improved.

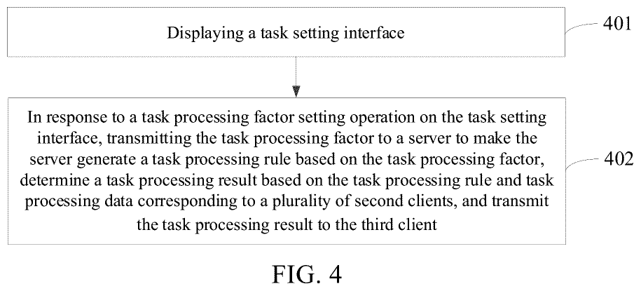

With reference to FIG. 4, FIG. 4 is a flowchart of a method for processing a task provided in an embodiment of the present disclosure. The method for processing the task of the present embodiment may be applied to the first client 101 as shown in FIG. 1. The method for processing the task includes the following steps.
401, displaying a task setting interface.
402, in response to a task processing factor setting operation on the task setting interface, transmitting the task processing factor to a server to make the server generate a task processing rule based on the task processing factor, determine a task processing result based on the task processing rule and task processing data corresponding to a plurality of second clients, and transmit the task processing result to the third client.

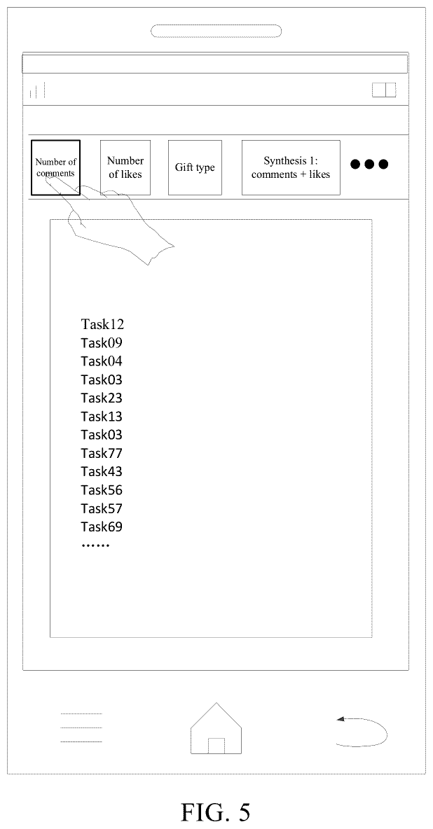

Exemplarily, after the streamer creates the live streaming room, in the live streaming process, the streamer may perform the setting operation on the task processing factor in the task setting interface. As shown in FIG. 5, the task setting interface may include the plurality of task processing factors, such as a number of comments, a number of likes, and a number of gifts, and may also include various combinations, e.g., synthesis 1, i.e., including the number of comments and the number of likes. Assuming that the user selects the number of comments as the task processing factor to generate the task processing rule based on the number of comments, the task processing rule may sort performance tasks in a descending order of the numbers of comments for the performance tasks.

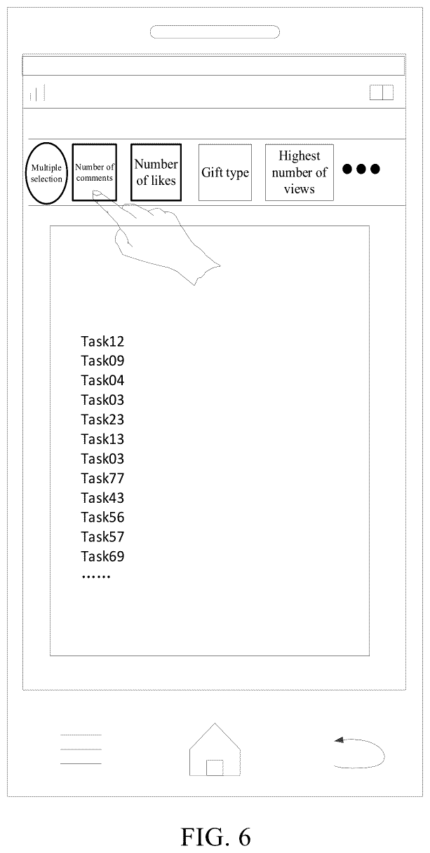

In one embodiment of the present disclosure, the task processing factor may include the plurality of factors. The generating the task processing rule for the plurality of performance tasks may include: performing weighted summation on each factor of the selected task processing factor to generate the task processing rule. There are a plurality of ways of selecting the plurality of task processing factors: in one implementation, as shown in FIG. 5, possible combinations may be provided for the user with synthesis options, assuming that the user selects synthesis 1: comments+likes, the task processing rule may be set as screening performance tasks based on weighted sums of the numbers of comments and the numbers of likes for the performance tasks. In another implementation, as shown in FIG. 6, a multiple-selection control may be set. When the user needs to select a plurality of task processing factors, multiple selection may be firstly selected, and then multiple options are made, assuming that the user selects the multiple-selection control and selects a number of comments and a number of likes as the task processing factors, the task processing rule may be set as screening performance tasks based on weighted sums of the numbers of comments and the numbers of likes. This is not limited in this embodiment of the present disclosure.

There may be a plurality of ways of selecting the sources of the performance tasks of the plurality of second clients corresponding to the task processing data.

In one implementation, the scope of the plurality of performance tasks may be set by default, e.g., set by default as the current live streaming room has terminated the performance tasks from the second clients participating in the performance in the live streaming room, or set by default as the performance tasks of a same type on the live streaming platform of a same day. An option control in a time dimension may be pushed to the user, for example, in response to a touch operation of the user on the option control in the time dimension, all performance tasks of the streamer from a starting date to an ending date may be acquired as the performance tasks of the plurality of second clients.

In another implementation, a plurality of performance tasks may be acquired in response to a selection operation acting on a processing scope factor in the task setting interface. In which the processing scope factor may include at least one of: a live streaming room identifier, a streamer account, a participating performer account, and starting and ending dates.

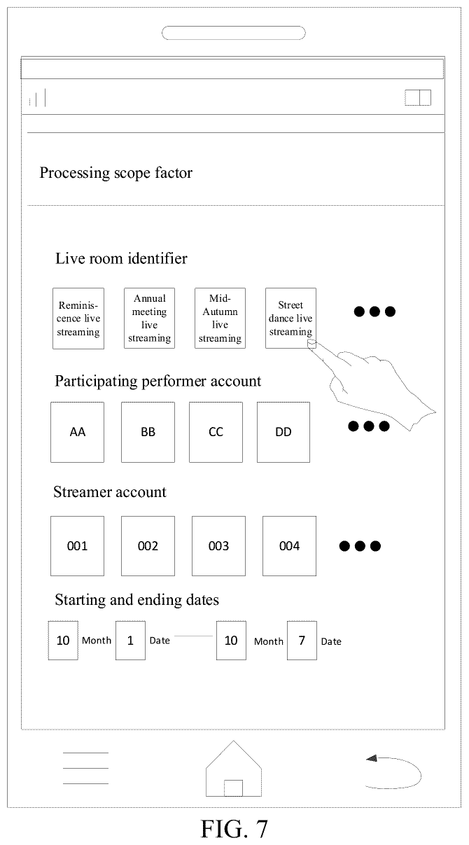

Exemplarily, as shown in FIG. 7, the following option controls of the processing scope factor may be pushed to the user: a live streaming room identifier control, a participating performer account control, a streamer account control, and starting and ending date controls. Taking the live streaming room identifier control for example, a plurality of live streaming room identifier controls (reminiscence live streaming, annual meeting live streaming, Mid-Autumn live streaming, or street dance live streaming) may be displayed. The user may select only one or more than two of the above controls, for example, the user may only select the live streaming room identifier, or select both of the streamer account and the starting and ending dates.

Exemplarily, as shown in FIG. 6, when the length of the task sorting result displayed on the current page exceeds a display height of one page, the task sorting result may be displayed on a plurality of pages. Moreover, the task in the present disclosure is not limited to the performance task, and may also be an activity task, a game task, and the like.

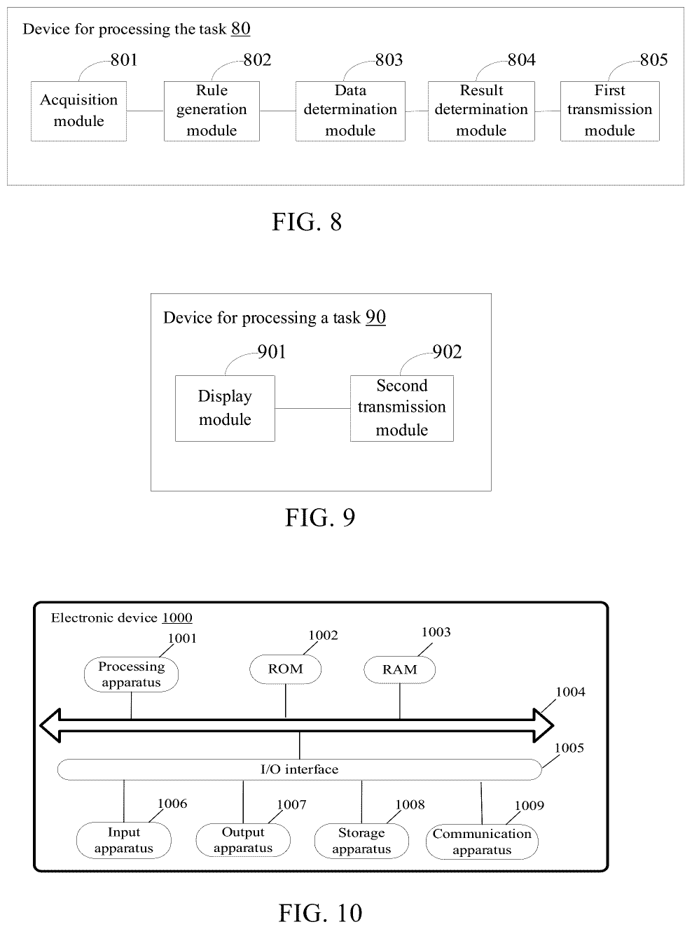

Corresponding to the method for processing the task of the embodiment shown in FIG. 2 above, FIG. 8 is the first structural block diagram of a device for processing a task provided in an embodiment of the present disclosure. For ease of illustration, only the portions relevant to the embodiments of the present disclosure are shown. Referring to FIG. 8, the device for processing the task 80 includes: an acquisition module 801, a rule generation module 802, a data determination module 803, a result determination module 804, and the first transmission module 805.

The acquisition module 801 is configured to acquire a task processing factor transmitted by the first client.

The rule generation module 802 is configured to generate a task processing rule based on the task processing factor.

The data determination module 803 is configured to determine task processing data corresponding to a plurality of second clients.

The result determination module 804 is configured to determine a task processing result based on the task processing rule and the task processing data.

The first transmission module 805 is configured to transmit the task processing result to the third client.

According to at least one embodiment of the present disclosure, the task processing result includes a task sorting result; the result determination module 804 is specifically configured to determine a task execution result corresponding to each second client based on the task processing rule and task processing data corresponding to each second client; and sort the task execution results corresponding to the second clients to acquire the task sorting result.

In an embodiment of the present disclosure, the task processing factor includes a plurality of factors, and the rule generation module 802 is specifically configured to perform weighted summation on each factor of the task processing factor to generate the task processing rule.

In an embodiment of the present disclosure, the data determination module 803 is specifically configured to acquire a task starting time and a task ending time corresponding to each second client of the plurality of second clients; and determine the task processing data corresponding to the plurality of second clients based on the task starting time and the task ending time corresponding to each second client.

In an embodiment of the present disclosure, the device 80 further includes: a storage module. The storage module is configured to store the task processing rule.

In an embodiment of the present disclosure, the device 80 further includes: a sequence length determination module. The sequence length determination module is configured to determine a target sequence length of the task sorting result; the rule generation module 802 is specifically configured to generate the task processing rule based on the task processing factor and the target sequence length.

In an embodiment of the present disclosure, the task is a task for a live streaming room, the data determination module 803 is specifically configured to acquire task processing data corresponding to the live streaming room, in which the live streaming room is a live streaming room where the first client, the second client, and the third client stay; and determine the task processing data corresponding to the plurality of second clients based on the task processing data corresponding to the live streaming room, and the task starting time and the task ending time corresponding to each second client.

In an embodiment of the present disclosure, the task processing data corresponding to the live streaming room includes a plurality of live streaming points and corresponding task processing data, and the plurality of live streaming points includes the task starting point and the task ending point corresponding to each second client; the data determination module 803 is specifically configured to determine task processing data corresponding to the task ending points and task processing data corresponding to the task starting points based on the plurality of live streaming points and the corresponding task processing data; and for each second client, determine a difference value between the task processing data corresponding to the task ending point and the task processing data corresponding to the task starting point as the task processing data.

The device provided in the present embodiment may be configured to execute the technical solution of the above-described method embodiment with the device for processing the task as the execution subject, and the realization principle and technical effect thereof are similar, and the present embodiment is not repeated here.

Corresponding to the method for processing the task of the embodiment shown in FIG. 4 above, FIG. 9 is the second structural block diagram of a device for processing a task provided in an embodiment of the present disclosure. For ease of illustration, only the portions relevant to the embodiments of the present disclosure are shown. Referring to FIG. 9, the device 90 includes: a display module 901 and the second transmission module 902.

The display module 901 is configured to display a task setting interface.

The second transmission module 902 is configured to in response to a task processing factor setting operation on the task setting interface, transmit the task processing factor to a server to make the server generate a task processing rule based on the task processing factor, determine a task processing result based on the task processing rule and task processing data corresponding to a plurality of second clients, and transmit the task processing result to the third client.

The device provided in the present embodiment can be used to execute the technical solution of the above method embodiment with the first client as the execution subject, and the realization principle and technical effect thereof are similar, so the present embodiment is not repeated here.

In order to realize the above embodiments, embodiments of the present disclosure further provide an electronic device.

Referring to FIG. 10, and it shows the structure schematic diagram suitable for achieving the electronic device 1000 in the embodiment of the present disclosure. The electronic device 1000 in the embodiment of the present disclosure may include but not be limited to a mobile terminal such as a mobile phone, a notebook computer, a digital broadcasting receiver, a Personal Digital Assistant (PDA), a Portable Android Device (PAD), a Portable Media Player (PMP), a vehicle terminal (such as a vehicle navigation terminal), and a fixed terminal such as a digital television (TV) and a desktop computer. The electronic device shown in FIG. 10 is only an example and should not impose any limitations on the functions and use scopes of the embodiments of the present disclosure.

As shown in FIG. 10, the electronic device 1000 may include a processing apparatus (such as a central processing unit, and a graphics processor) 1001, it may execute various appropriate actions and processes according to a program stored in a read-only memory (ROM) 1002 or a program loaded from a storage apparatus 1008 to a random access memory (RAM) 1003. In RAM 1003, various programs and data required for operations of the electronic device 1000 are also stored. The processing apparatus 1001, ROM 1002, and RAM 1003 are connected to each other by a bus 1004. An input/output (I/O) interface 1005 is also connected to the bus 1004.

Typically, the following apparatuses may be connected to the I/O interface 1005: an input apparatus 1006 such as a touch screen, a touchpad, a keyboard, a mouse, a camera, a microphone, an accelerometer, and a gyroscope; an output apparatus 1007 such as a liquid crystal display (LCD), a loudspeaker, and a vibrator; a storage apparatus 1008 such as a magnetic tape, and a hard disk drive; and a communication apparatus 1009. The communication apparatus 1009 may allow the electronic device 1000 to wireless-communicate or wire-communicate with other devices so as to exchange data. Although FIG. 10 shows the electronic device 1000 with various apparatuses, it should be understood that it is not required to implement or possess all the apparatuses shown. Alternatively, it may implement or possess the more or less apparatuses.

Specifically, according to the embodiment of the present disclosure, the process described above with reference to the flow diagram may be achieved as a computer software program. For example, an embodiment of the present disclosure includes a computer program product, it includes a computer program loaded on a non-transient computer-readable medium, and the computer program contains a program code for executing the method shown in the flow diagram. In such an embodiment, the computer program may be downloaded and installed from the network by the communication apparatus 1009, or installed from the storage apparatus 1008, or installed from ROM 1002. When the computer program is executed by the processing apparatus 1001, the above functions defined in the method in the embodiments of the present disclosure are executed.

It is noted that the above computer-readable medium in the present disclosure may be a computer-readable signal medium, a computer-readable storage medium, or any combinations of the two. The computer-readable storage medium may be, for example, but not limited to, a system, an apparatus or a device of electricity, magnetism, light, electromagnetism, infrared, or semiconductor, or any combinations of the above. More specific examples of the computer-readable storage medium may include but not be limited to: an electric connector with one or more wires, a portable computer magnetic disk, a hard disk drive, a random access memory (RAM), a read-only memory (ROM), an erasable programmable read-only memory (EPROM or flash memory), an optical fiber, a compact disk-read only memory (CD-ROM), an optical storage device, a magnetic storage device or any suitable combinations of the above. In the present disclosure, the computer-readable storage medium may be any visible medium that contains or stores a program, and the program may be used by an instruction executive system, apparatus or device or used in combination with it. In the present disclosure, the computer-readable signal medium may include a data signal propagated in a baseband or as a part of a carrier wave, it carries the computer-readable program code. The data signal propagated in this way may adopt various forms, including but not limited to an electromagnetic signal, an optical signal, or any suitable combinations of the above. The computer-readable signal medium may also be any computer-readable medium other than the computer-readable storage medium, and the computer-readable signal medium may send, propagate, or transmit the program used by the instruction executive system, apparatus or device or in combination with it. The program code contained on the computer-readable medium may be transmitted by using any suitable medium, including but not limited to: a wire, an optical cable, a radio frequency (RF) or the like, or any suitable combinations of the above.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to perform the method shown in the above-described embodiments.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances, for example, the first acquisition module can also be described as “a module that acquires at least two Internet protocol addresses”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, compact disk-read only memory (CD-ROM), optical storage device, magnetic storage device, or any suitable combination of the foregoing.

In the first aspect, according to at least one embodiment of the present disclosure, there is provided a method for processing a task, which includes:
acquiring a task processing factor transmitted by the first client;
generating a task processing rule based on the task processing factor;
determining task processing data corresponding to a plurality of second clients;
determining a task processing result based on the task processing rule and the task processing data; and
transmitting the task processing result to the third client.

According to at least one embodiment of the present disclosure, the task processing result includes a task sorting result; and the determining a task processing result based on the task processing rule and the task processing data, includes: determining a task execution result corresponding to each second client based on the task processing rule and task processing data corresponding to each second client; and sorting the task execution results corresponding to the second clients to acquire the task sorting result.

According to at least one embodiment of the present disclosure, the task processing factor includes a plurality of factors, and the generating a task processing rule based on the task processing factor, includes: performing weighted summation on each factor of the task processing factor to generate the task processing rule.

According to at least one embodiment of the present disclosure, the determining task processing data corresponding to a plurality of second clients, includes: acquiring a task starting time and a task ending time corresponding to each second client of the plurality of second clients; determining the task processing data corresponding to the plurality of second clients based on the task starting time and the task ending time corresponding to each second client.

According to at least one embodiment of the present disclosure, after the generating a task processing rule based on the task processing factor, the method further including: storing the task processing rule.

According to at least one embodiment of the present disclosure, before the generating a task processing rule based on the task processing factor, the method further including: determining a target sequence length of the task sorting result; in which the generating a task processing rule based on the task processing factor, includes: generating the task processing rule based on the task processing factor and the target sequence length.

According to at least one embodiment of the present disclosure, the task is a task for a live streaming room; and the determining task processing data corresponding to a plurality of second clients, includes: acquiring task processing data corresponding to the live streaming room, in which the live streaming room is a live streaming room where the first client, the second clients, and the third client stay; and determining the task processing data corresponding to the plurality of second clients based on the task processing data corresponding to the live streaming room, and the task starting time and the task ending time corresponding to each second client.

According to at least one embodiment of the present disclosure, the task processing data corresponding to the live streaming room includes a plurality of live streaming points and corresponding task processing data; the plurality of live streaming points includes the task starting point and the task ending point corresponding to each second client; and the determining the task processing data corresponding to the plurality of second clients based on the task processing data corresponding to the live streaming room, and the task starting time and the task ending time corresponding to each second client, includes: determining task processing data corresponding to the task ending points and task processing data corresponding to the task starting points based on the plurality of live streaming points and the corresponding task processing data; and for each second client, determining a difference value between the task processing data corresponding to the task ending point and the task processing data corresponding to the task starting point as the task processing data.

In the second aspect, according to at least one embodiment of the present disclosure, there is provided a method for processing a task, which includes: displaying a task setting interface; and in response to a task processing factor setting operation on the task setting interface, transmitting the task processing factor to a server to make the server generate a task processing rule based on the task processing factor, determine a task processing result based on the task processing rule and task processing data corresponding to a plurality of second clients, and transmit the task processing result to the third client.

According to at least one embodiment of the present disclosure, after the displaying the task setting interface, the method further includes, in response to a processing scope factor setting operation on the task setting interface, transmitting the processing scope factor to a server to make the server terminal determine the task processing data corresponding to the plurality of second clients based on the processing scope factor.

In the third aspect, according to at least one embodiment of the present disclosure, there is provided a device for processing a task, which includes: an acquisition module, a rule generation module, a data determination module, a result determination module, and the first transmission module. The acquisition module is configured to acquire a task processing factor transmitted by the first client. The rule generation module is configured to generate a task processing rule based on the task processing factor. The data determination module is configured to determine task processing data corresponding to a plurality of second clients. The result determination module is configured to determine a task processing result based on the task processing rule and the task processing data. The first transmission module is configured to transmit the task processing result to the third client.

According to at least one embodiment of the present disclosure, the task processing result includes a task sorting result; the result determination module is specifically configured to determine a task execution result corresponding to each second client based on the task processing rule and task processing data corresponding to each second client; and sort the task execution results corresponding to the second clients to acquire the task sorting result.

According to at least one embodiment of the present disclosure, the task processing factor includes a plurality of factors, and the rule generation module is specifically configured to perform weighted summation on each factor of the task processing factor to generate the task processing rule.

According to at least one embodiment of the present disclosure, the data determination module is specifically configured to acquire a task starting time and a task ending time corresponding to each second client of the plurality of second clients; and determine the task processing data corresponding to the plurality of second clients based on the task starting time and the task ending time corresponding to each second client.

According to at least one embodiment of the present disclosure, the device further includes: a storage module. The storage module is configured to store the task processing rule.

According to at least one embodiment of the present disclosure, the device further includes: a sequence length determination module. The sequence length determination module is configured to determine a target sequence length of the task sorting result; the rule generation module is specifically configured to generate the task processing rule based on the task processing factor and the target sequence length.

According to at least one embodiment of the present disclosure, the task is a task for a live streaming room, the data determination module is specifically configured to acquire task processing data corresponding to the live streaming room, in which the live streaming room is a live streaming room where the first client, the second client, and the third client stay; and determine the task processing data corresponding to the plurality of second clients based on the task processing data corresponding to the live streaming room, and the task starting time and the task ending time corresponding to each second client.

According to at least one embodiment of the present disclosure, the task processing data corresponding to the live streaming room includes a plurality of live streaming points and corresponding task processing data; the plurality of live streaming points includes the task starting point and the task ending point corresponding to each second client; the data determination module is specifically configured to determine task processing data corresponding to the task ending points and task processing data corresponding to the task starting points based on the plurality of live streaming points and the corresponding task processing data; and for each second client, determine a difference value between the task processing data corresponding to the task ending point and the task processing data corresponding to the task starting point as the task processing data.

In the fourth aspect, according to at least one embodiment of the present disclosure, there is provided a device for processing a task, which includes: a display module and the second transmission module. The display module is configured to display a task setting interface. The second transmission module is configured to in response to a task processing factor setting operation on the task setting interface, transmit the task processing factor to a server to make the server generate a task processing rule based on the task processing factor, and determine a task processing result based on the task processing rule and task processing data corresponding to a plurality of second clients, and transmit the task processing result to the third client.

According to at least one embodiment of the present disclosure, the device further includes: the third transmission module. The third transmission module is configured to in response to a processing scope factor setting operation on the task setting interface, transmit the processing scope factor to a server to make the server terminal determine the task processing data corresponding to the plurality of second clients based on the processing scope factor.

In the fifth aspect, according to at least one embodiment of the present disclosure, there is provided an electronic device includes: a processor and a memory.

The memory stores computer executable instructions.

The processor executes the computer executable instructions stored on the memory, causing the processor to perform the method for processing the task as described in the first aspect above and in various possible designs of the first aspect.

In the sixth aspect, according to at least one embodiment of the present disclosure, there is provided an electronic device includes: a display, a processor and a memory.

The memory stores computer executable instructions, the display is connected to the processor and configured to display a task setting interface.

The processor executes the computer executable instructions stored on the memory, causing the at least one processor to perform the method for processing the task as described in the second aspect above.

In the seventh aspect, according to at least one embodiment of the present disclosure, there is provided a computer readable storage medium, computer executable instructions are stored in the computer readable storage medium, and the computer executable instructions when executed by a processor, implement the method for processing the task as described in the first aspect above and in various possible designs of the first aspect, or, implement the method for processing the task as described in the second aspect above.

In the eighth aspect, according to at least one embodiment of the present disclosure, there is provided a computer program product including a computer program, the computer program when executed by a processor, implements the method for processing the task as described in the first aspect above and in various possible designs of the first aspect, or, implements the method for processing the task as described in the second aspect above.

In the ninth aspect, according to at least one embodiment of the present disclosure, there is provided a computer program, the computer program when executed by a processor, implements the method for processing the task as described in the first aspect above and in various possible designs of the first aspect, or, implements the method for processing the task as described in the second aspect above.

The above description is merely a preferred embodiment of the present disclosure and an illustration of the technical principles utilized. It should be understood by those skilled in the art that the scope of the disclosure involved in the present disclosure is not limited to a technical solution formed by a particular combination of the above-described technical features, but also covers other technical solutions formed by any combination of the above-described technical features or their equivalent without departing from the above-described disclosure concept. For example, a technical solution formed by interchanging the above-mentioned features with (but not limited to) technical features having similar functions disclosed in the present disclosure.

Furthermore, although the operations are depicted using a particular order, this should not be construed as requiring that the operations be performed in the particular order shown or in a sequential order of execution. Multitasking and parallel processing may be advantageous in certain environments. Similarly, while several specific implementation details are included in the above discussion, these should not be construed as limiting the scope of the present disclosure. Certain features described in the context of separate embodiments may also be implemented in combination in a single embodiment. Conversely, various features described in the context of a single embodiment may also be implemented in multiple embodiments, either individually or in any suitable sub-combination.

Although the present subject matter has been described using language specific to structural features and/or method logic actions, it should be understood that the subject matter defined in the appended claims is not necessarily limited to the particular features or actions described above. Rather, the particular features and actions described above are merely exemplary forms of realizing the claims.

What is claimed is:

1. A method for processing a task, comprising:
acquiring a task processing factor transmitted by a first client;
generating a task processing rule based on the task processing factor;
determining task processing data corresponding to a plurality of second clients;
determining a task processing result based on the task processing rule and the task processing data; and
transmitting the task processing result to a third client.

2. The method according to claim 1, wherein the task processing result comprises a task sorting result;
the determining a task processing result based on the task processing rule and the task processing data, comprises:
determining a task execution result corresponding to each second client based on the task processing rule and task processing data corresponding to each second client; and
sorting the task execution results corresponding to the second clients to acquire the task sorting result.

3. The method according to claim 1, wherein the task processing factor comprises a plurality of factors, and the generating a task processing rule based on the task processing factor, comprises:
performing weighted summation on each factor of the task processing factor to generate the task processing rule.

4. The method according to claim 1, wherein the determining task processing data corresponding to a plurality of second clients, comprises:
acquiring a task starting time and a task ending time corresponding to each second client of the plurality of second clients; and
determining the task processing data corresponding to the plurality of second clients based on the task starting time and the task ending time corresponding to each second client.

5. The method according to claim 1, after the generating a task processing rule based on the task processing factor, further comprising: storing the task processing rule.

6. The method according to claim 2, before the generating a task processing rule based on the task processing factor, further comprising:
determining a target sequence length of the task sorting result;
wherein the generating a task processing rule based on the task processing factor, comprises:
generating the task processing rule based on the task processing factor and the target sequence length.

7. The method according to claim 1, wherein the task is a task for a live streaming room, and the determining task processing data corresponding to a plurality of second clients, comprises:
acquiring task processing data corresponding to the live streaming room, wherein the live streaming room is a live streaming room where the first client, the second client, and the third client stay; and
determining the task processing data corresponding to the plurality of second clients based on the task processing data corresponding to the live streaming room, and a task starting time and a task ending time corresponding to each second client.

8. The method according to claim 7, wherein the task processing data corresponding to the live streaming room comprises a plurality of live streaming points and corresponding task processing data, and the plurality of live streaming points comprise a task starting point and a task ending point corresponding to each second client;
the determining the task processing data corresponding to the plurality of second clients based on the task processing data corresponding to the live streaming room, and a task starting time and a task ending time corresponding to each second client, comprises:
determining task processing data corresponding to the task ending point and task processing data corresponding to the task starting point based on the plurality of live streaming points and the corresponding task processing data; and
for each second client, determining a difference value between the task processing data corresponding to the task ending point and the task processing data corresponding to the task starting point as the task processing data.

9. A method for processing a task, applied to a first client, comprising:
displaying a task setting interface; and
in response to a task processing factor setting operation on the task setting interface, transmitting the task processing factor to a server to make the server generate a task processing rule based on the task processing factor, determine a task processing result based on the task processing rule and task processing data corresponding to a plurality of second clients, and transmit the task processing result to a third client.

10. A device for processing a task, comprising:
an acquisition module, configured to acquire a task processing factor transmitted by a first client;
a rule generation module, configured to generate a task processing rule based on the task processing factor;
a data determination module, configured to determine task processing data corresponding to a plurality of second clients;
a result determination module, configured to determine a task processing result based on the task processing rule and the task processing data; and
a first transmission module, configured to transmit the task processing result to a third client.

11. (canceled)

12. An electronic device, comprising a processor and a memory,
wherein the memory stores computer executable instructions; and
the processor executes the computer executable instructions stored on the memory, causing the processor to perform the method for processing a task according to claim 1.

13. An electronic device, comprising a display, a processor, and a memory,
wherein the memory stores computer executable instructions, the display is connected to the processor and configured to display a task setting interface; and
the processor executes the computer executable instructions stored on the memory, causing the processor to perform the method for processing a task according to claim 9.

14. A computer readable storage medium, wherein computer executable instructions are stored in the computer readable storage medium, and the computer executable instructions, when executed by a processor, implement the method for processing a task according to claim 1.

15-16. (canceled)

17. A computer readable storage medium, wherein computer executable instructions are stored in the computer readable storage medium, and the computer executable instructions, when executed by a processor, implement the method for processing a task according to claim 9.

18. The device according to claim 10, wherein the task processing result comprises a task sorting result;
the result determination module is further configured to determine a task execution result corresponding to each second client based on the task processing rule and task processing data corresponding to each second client; and
sort the task execution results corresponding to the second clients to acquire the task sorting result.

19. The device according to claim 10, wherein the task processing factor comprises a plurality of factors, and the rule generation module is further configured to:
perform weighted summation on each factor of the task processing factor to generate the task processing rule.

20. The device according to claim 10, wherein the data determination module is further configured to:
acquire a task starting time and a task ending time corresponding to each second client of the plurality of second clients; and
determine the task processing data corresponding to the plurality of second clients based on the task starting time and the task ending time corresponding to each second client.

21. The device according to claim 10, further comprising:
a storage module, configured to store the task processing rule.

22. The device according to claim 18, further comprising:
a sequence length determination module, configured to determine a target sequence length of the task ranking result;
wherein the rule generation module is further configured to generate the task processing rule based on the task processing factor and the target sequence length.

23. The device according to claim 10, wherein the task is a task for a live streaming room, and the data determination module is further configured to:
acquire task processing data corresponding to the live streaming room, wherein the live streaming room is a live streaming room where the first client, the second client, and the third client stay; and
determine the task processing data corresponding to the plurality of second clients based on the task processing data corresponding to the live streaming room, and a task starting time and a task ending time corresponding to each second client.
